(19) United States
(12) Patent Application Publication
(10) Pub. No.: US 2015/0046273 A1
(43) Pub. Date: Feb. 12, 2015

(54) Decision Engine For Payments

(71) Applicant: Data Business Systems, Inc., Virginia Beach, VA (US)

(72) Inventor: David Robin Vaughan, Raleigh, NC (US)

(21) Appl. No.: 14/312,821

(22) Filed: Jun. 24, 2014

Related U.S. Application Data
(60) Provisional application No. 61/863,202, filed on Aug. 7, 2013.

(51) Int. Cl. G06Q 20/22; G06Q 20/20

(52) U.S. Cl. CPC G06Q 20/227; G06Q 20/20
USPC 705/16

(57) ABSTRACT

A system and method that changes the payment flow at the point of sale and an EFT device based upon the Transaction Factors, so that the customer is guided during their interaction with the transaction based upon the card that they are utilizing, the payment types supported by that card, and their cash back selection, such that the transaction incurs the least cost for the retailer.

This application claims the benefit of U.S. Provisional Patent Application 61/863,201, filed on Aug. 7, 2013.

### FIELD OF THE INVENTION

The embodiments disclosed herein relate to a system architecture and a method to reduce fees and costs associated with electronic point-of-sale payments, while maximizing fees collected during the transaction. In particular, the present invention reduces costs associated with the authorization and settlement of credit and debit card transactions.

### BACKGROUND OF THE INVENTION

Credit and debit cards, along with the advent of electronic sales and services transactions, have changed forever how the U.S. and global marketplaces function. Point-of-sale purchases are those purchases made at the physical location where the retail goods or services are provided. Retailers accept a wide variety of payment methods, each of which carries with it its own processing and handling costs, and impacts the handling of customers (both physically and electronically) in different ways. Transactions of this type are generally handled by and through an electronic fund transfer (EFT) device, such as the combination of a cash register and a debit/credit card reader.

If a retailer were able to choose for each customer the specific payment to use for a given transaction, the decision would be based upon a number of factors (the “Transaction Factors”), including:
The balance of the transaction
The payment methods that the customer has available
The payment types available for a given payment method, such as Debit or Signature Cards
Whether the customer will be requesting cash back on the transaction, and if there are fees captured or other benefits associated with the cash back transaction
Third party discounts or incentives associated with a given payment type
Chargeback or inquiry rates associated with a given payment type, and the costs of retaining a signature or receipt
The length of time to process the customer in the lane (e.g., whether or not a signature is required)
The impact of payment choices on the availability of funds
Store-related costs associated with the labor for a particular payment type
Fees associated with authorizing and settling the card payment utilizing a particular payment type (e.g., whether or not the bank providing the card is regulated or unregulated under the Durbin Amendment)
Other changes and impacts that occur as a result of changes in banking and regulatory structures, fee agreements, and the like

Technologies exist to process point-of-sale electronic payments. However, prior payment processing means are limited in that payment handling was determined solely from the first digits of the card at issue. The use of the above Transaction Factors is needed in order to minimize the retailer's cost at the point of the sale.

What is needed, therefore, is a system and method that changes the payment flow at the point of sale and an EFT device based upon the Transaction Factors, so that the customer is guided during their interaction with the transaction based upon the card that they are utilizing, the payment types supported by that card, and their cash back selection, such that the transaction incurs the least cost for the retailer.

While the discussion herein discusses the invention in terms of retail sales, it will be understood that the method may be applied to other transactions, such as service sales, wholesale purchases, and the like.

### SUMMARY OF THE INVENTION

The present invention is related to a system for handling and authorizing point of sale payments. In particular, the present invention dynamically alters the manner in which a payment is handled in a point of sale transaction such that the retailer's costs are minimized.

### BRIEF DESCRIPTION OF THE DRAWINGS

FIG. 1 illustrates the High Level Flow of the present invention.

FIG. 2 illustrates the inputs to cost that are utilized in dynamically predicting costs of payment handling.

FIG. 3 illustrates the elements utilized to generate a recommended transaction.

FIG. 4 illustrates an embodiment of the present invention showing a dynamically-guided consumer purchase process.

FIG. 5 illustrates an embodiment of the present invention showing decision components for a dynamically guided consumer purchase process in accordance with an embodiment of the present invention.

FIG. 6 illustrates a system in accordance with an embodiment of the present invention.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made.

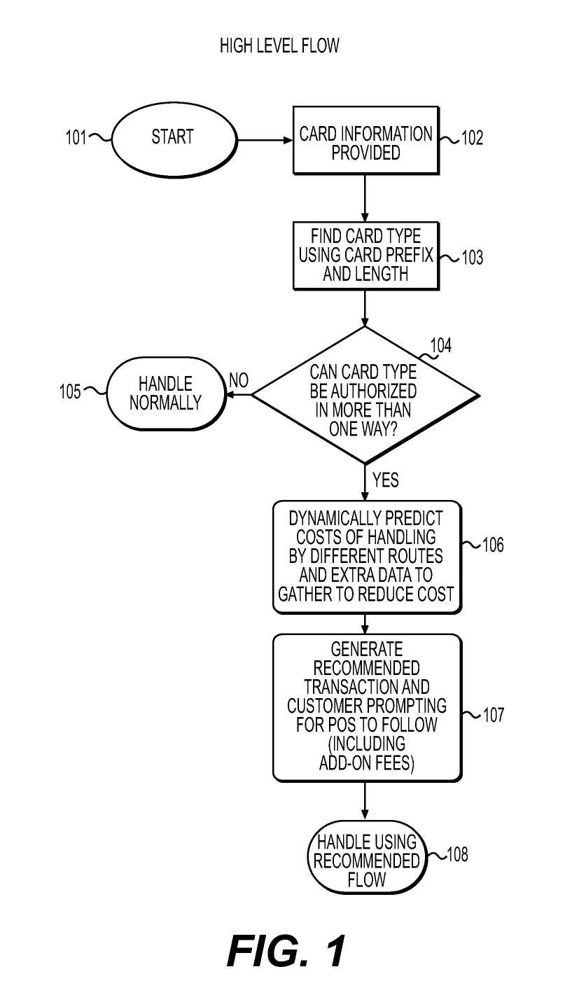

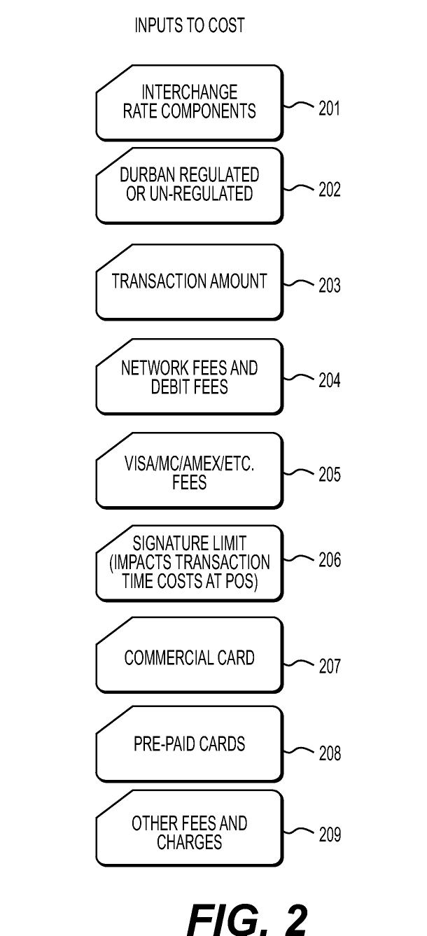

Referring now to FIG. 1, a High Level Flow of the present invention is shown. At the start 101, the card information is provided 102. This is generally done through the process of a point of sale customer “swiping” the magnetic strip located on credit and debit cards through an electronic card reader, but the card information may also be provided by manually keying in the care information at the point of sale register, or by other means. The card type is determined 103 by utilizing the card prefix and the length of the card number. Once the card type is determined 103, whether or not the card can be authorized in more than one way is determined 104. If the card cannot be authorized in more than one way, the transaction is handled normally 105 with no dynamic prediction 106. If the card may be authorized in more than one manner, the costs of handling are dynamically predicted 106, utilizing the Inputs to Cost (FIG. 2). Once the costs of handling are predicted 106, a recommended transaction and customer prompting is generated 107, based upon the dynamic prediction 106 of the transaction with the least transaction costs for the point of sale retailer. The transaction is then handled 108 utilizing the recommended transaction.

Referring now to FIG. 2, Inputs to Cost that are utilized for the step of dynamically predicting (FIG. 1, 106) the costs of handling. These Inputs may comprise: interchange rate components 201; the presence or lack of Durban regulations 202 (Durbin regulations allow the U.S. Federal Reserve the power to regulate debit card interchange fees); the transaction amount 203; network and debit fees 204; card issuer (Visa, MasterCard, American Express, etc.) fees 205; any applicable signature limit 206, which impacts transaction costs at the point of sale, whether the card is a commercial card 207, whether the card is a pre-paid card 208, and other associated fees and costs 209. It will be understood that this list is not exhaustive; transaction costs change not just in value but in type over time, and the present invention takes into account this shifting landscape of Inputs to Cost.

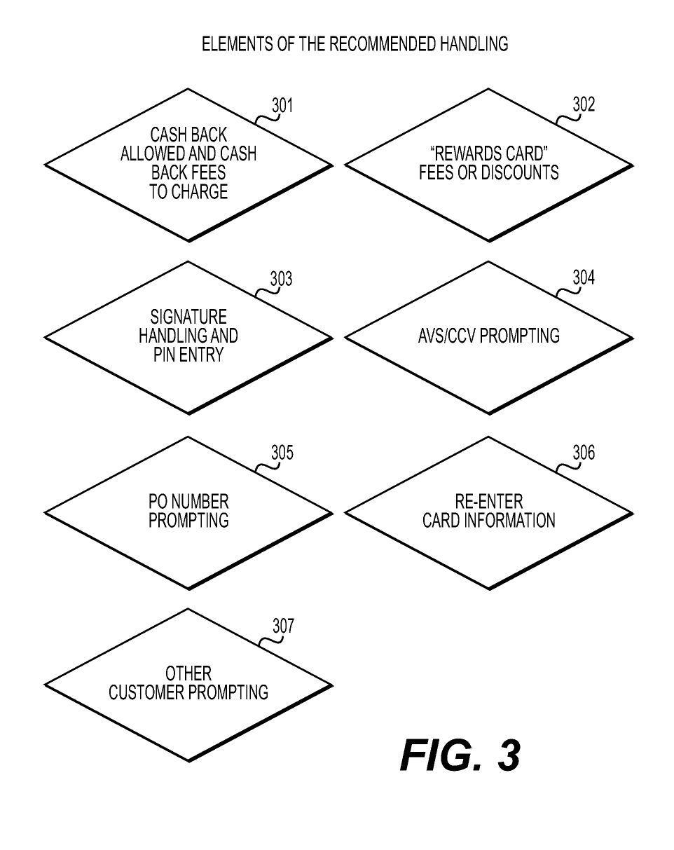

Referring now to FIG. 3, once the costs of handling are dynamically predicted (FIG. 1, 106), the generation of the recommended transaction and customer prompting (FIG. 1, 107) is comprised of one or more elements. These elements include: cash back awards and cash back fees to charge 301; “rewards” card fees or discounts 302; signature handling and PIN entry 303; AVS/CCV prompting 304 (these are the three- or four-digit security numbers utilized on credit and debit cards); PO number prompting 305, whether or not to re-enter the card information 306, and other customer prompting 307. It will be understood that the Elements of Recommended Handling identified herein is not exhaustive. There are changes to card processing that occur over time, and the present invention is structured such that those changes will be taken into account as they occur for recommending transaction and customer prompting.

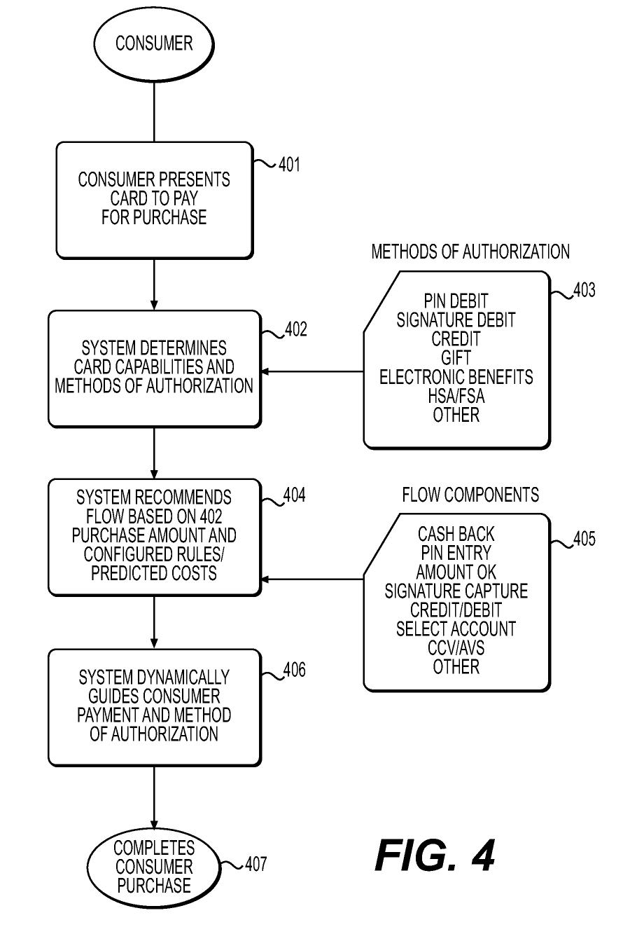

FIG. 4 shows an alternate flow chart in accordance with an embodiment of the present invention. A consumer presents a card to pay for a purchase 401. The system determines 402 the card capabilities and the methods of authorization. The methods of authorization 403 can include such parameters as pin debit, signature debit, credit, gift, electronic benefits, HSA/FSA, or other authorization methods. It will be understood that, as the marketplace progresses and changes, available authorization methods may change and such new or changed authorization methods can be incorporated into the present invention without deviating from the scope of the invention. The system then recommends flow 404 based upon the system determinations in 402, as well as the purchase amount and configured rules/predicted costs. The flow components 405 may include cash back, PIN entry, amount ok (authorization of purchase) signature capture, the choice of credit or debit, selection of account that the card is associated with, or other flow components. As with the methods of authorization 403, it will be understood that the set of flow components to choose from may change as the marketplace use of cards is modified and evolves, and the set of potential flow components may change without deviating from the scope of the present invention. Once the system has recommended a flow 404, the system dynamically guides 406 the consumer payment and method of authorization and completes the customer purchase 407.

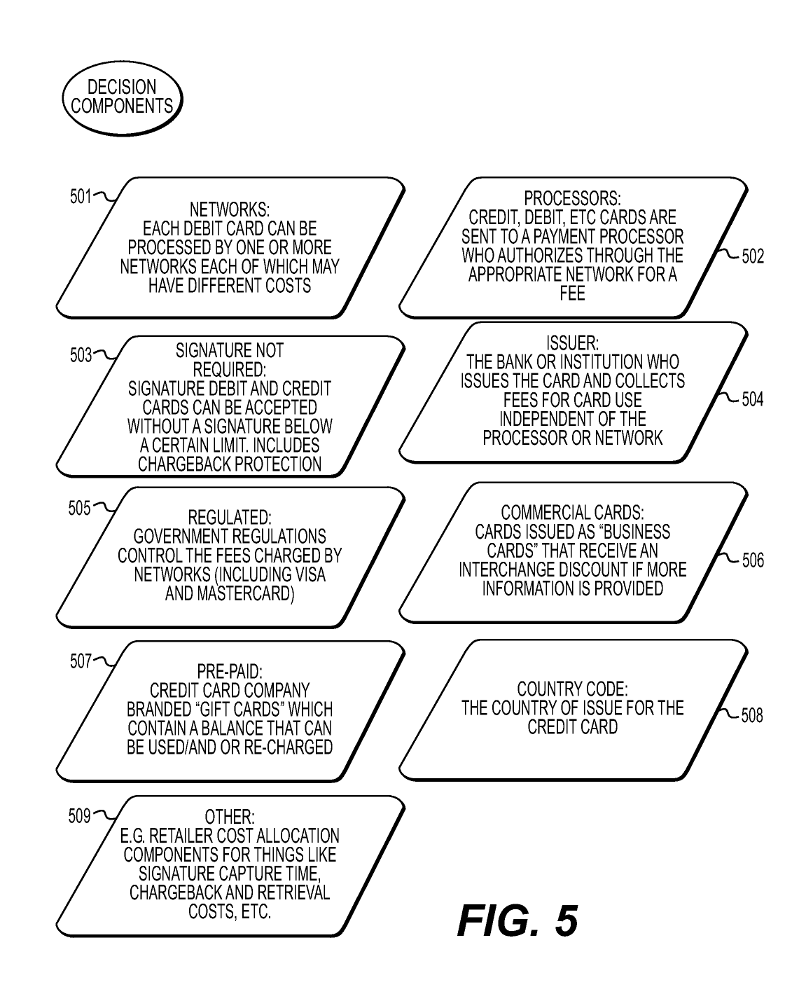

Decision components (FIG. 5) for determining the flow for dynamically guiding the customer's payment and method of authorization include networks 501, processors 502, signature not required 503, issuer 504, regulated 505, commercial cards 506, pre-paid 507, country code 508, or other components 509. For networks 501, each debit card can be processed by one or more networks, each of which may have different costs which are considered when guiding the purchasing process. For processors 502, requests for payments on credit or debit cards, the information is sent to a payment processor. The payment processor authorizes the payment through an appropriate network and charges a fee for doing so. Below a certain purchase limit, signatures may not be required 503 for a particular card. This component further includes chargeback protection. The system also considers the issuer 504; the bank or institution that issued the card and collects fees for the card's use independent of the network 501 or the processor 502. The system also considers whether or not the transaction is regulated 505. Government regulations control the fees charged by networks (501) and are taken into consideration when determining a recommended system flow. There are also commercial cards 506. Commercial cards are issued as “business cards” that receive an interchange discount if more information is provided. Pre-paid 507 cards include credit card company branded “gift cards.” Such “gift cards” contain a balance placed upon them at the time of the purchase of the gift card. The balance is depleted as it is used, and in some cases the card allows the balance to be refilled or re-charged with payments to add additional monetary value to the card. The system further considers the country code 508, which identifies the country of issue for the card. Finally, there may be other 509 components taken into account by the system, such as retailer cost allocation and components for additional items such as signature capture time, chargeback and retrieval costs, and the like. These other 509 components may also change, be added to or modified as the marketplace and cards change to include other components. Such changes, additions or modifications will be understood to not fall outside the scope and intention of the present invention.

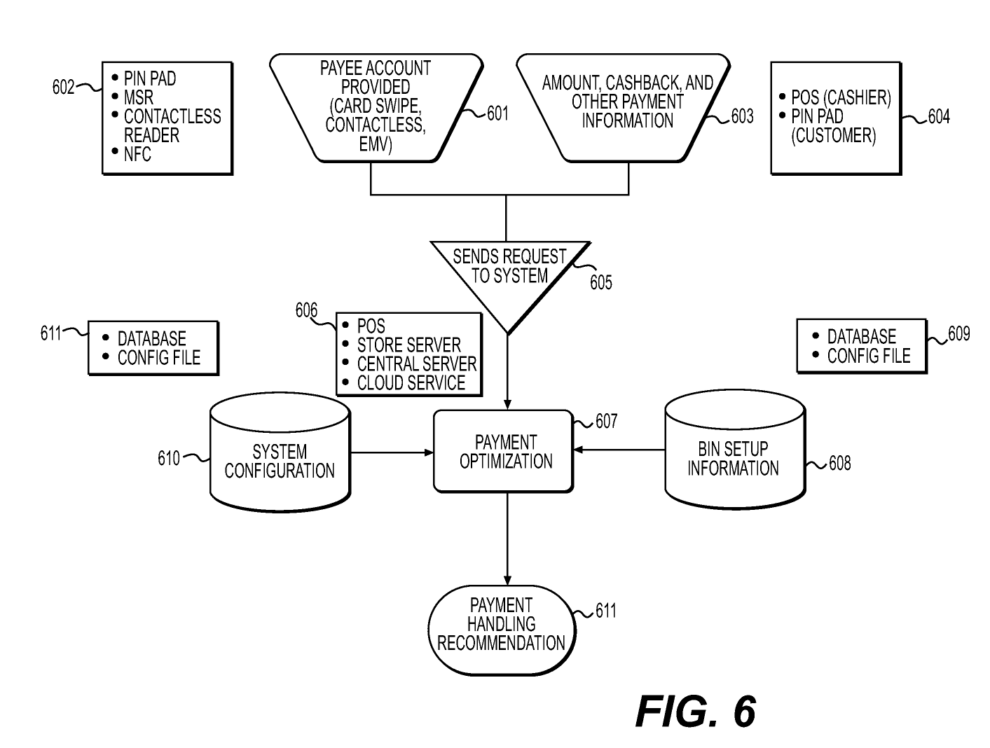

FIG. 6 shows a system configuration in accordance with an embodiment of the invention. A first input interface 601 receives account information from a payee. The payment interface device 601 may be chosen from the list comprising 602 a PIN Pad, MSR (magnetic card (stripe) reader), a contactless card reader, an NFC device (near field communication device), or similar device. Through 604 point of sale information entered by the cashier or by the customer, a second input interface 603 communicates second information to the system, second information being the amount, cashback and other payment information. In a standard configuration, the cashier operates a register that may also be used as a first and second input interface, and communicates with the payment interface device 601.

The payment request is sent 605 to the system processor 606. The system processor 606 may be resident in the payment interface device 601, a store server, a central server, or may be provided through a cloud service. A third input interface 608 communicates third information to the system 607, the third information being permitted authorization methods and payee account handling options based upon the prefix of the payee account. The third input interface 608 communicates BIN (bank identification number) setup information to the system, the BIN setup information may comprise information 609 from a database or a Config file. A fourth input interface 610 communicates fourth information 611 to the system, the fourth information containing the configuration of desired payee account handling based upon the second and third information derived from the first information. The first, second, and third information are processed by the system to determine the configuration of desired payee account handling, and the payment optimization 607. Once payment optimization 607 is determined by the system, the payment handling recommendation 612 is communicated to the payment interface devices.

The above description and drawings illustrate embodiments which achieve the objects, features, and advantages described. Although certain advantages and embodiments have been described above, those skilled in the art will recognize that substitutions, additions, deletions, modifications and/or other changes may be made.

What is claimed is:

1. A method for handling a customer payment interaction at a point of sale utilizing an electronic fund transfer (“EFT”) device and processing a customer payment where the payment flow is changed at the point of sale and EFT device based upon transaction factors.

2. The method of claim 1 wherein transaction factors are chosen from the list consisting of the balance of the transaction; the payment methods available to the customer; the payment types available for a given payment method, such as debit or signature cards; whether the customer will be requesting cash back on the transaction and if there are fees captured or other benefits associated with the cash back transaction; third party discounts or incentives associated with a given payment type; chargeback or inquiry rates associated with a given payment type and the costs of retaining a signature or receipt; the length of time to process the customer in a purchase setting such as in a checkout line and whether or not a signature is required; the impact of payment choices on the availability of funds; store-related costs associated with the labor for a particular payment type; fees associated with the authorizing and settling the card payment utilizing a particular payment type, e.g., whether or not the bank providing the card is regulated or unregulated; and other changes and impacts that occur as a result of changes in banking and regulatory structures and fee agreements.

3. The method of claim 2 wherein the customer is guided during their interaction with the transaction based upon the card that they are utilizing, the payment types supported by that card, and their cash back selection, such that the transaction incurs the least cost for the retailer.

4. The method of claim l comprising the steps of determining a customer payment card number by utilizing the card prefix and the length of the card number, determining whether or not the card can be authorized in more than one manner, and if the card can be authorized in more than one manner then dynamically predicting the costs of handling the purchase transaction.

5. The method of claim 4, further comprising the step of recommending a transaction and prompting a customer to utilize a transaction based upon the dynamic prediction of the transaction with the least transaction costs for the point of sale retailer.

6. The method of claim 5, further comprising the step of handling the transaction utilizing the recommended transaction.

7. The method of claim 5, wherein the dynamic prediction of costs of handling the purchase transaction is determined based upon a set of criteria, the set of criteria comprising: interchange rates components, the presence or lack of regulations, the transaction amount, network and debit fees, card issuer fees, any applicable signature limit; whether the card is a commercial card, and whether the card is a pre-paid card.

8. The method of claim 7 wherein generating a recommended transaction and customer prompting is comprises of one or more elements, the one or more elements being chosen from the group comprising: cash back awards and cash fees to charge; “rewards” card fees or discounts; signature handling and PIN entry; AVS/CCV prompting; PO number prompting; and whether or not to re-enter some or all of the card information.

9. A method of processing a customer card payment, the method comprising the steps of: a customer presenting a card for payment; determining the card capabilities and methods of authorization; and recommending a purchase flow based upon the card capabilities and methods of authorization.

10. The method of claim 9 wherein the purchase flow is comprised of components chosen from a group comprising: cash back; PIN entry; purchase authorization; signature capture; choice of credit or debit purchase; and selection of account that the card is associated with.

11. The method of claim 10 further comprising the step of guiding the consumer payment and method of authorization by utilizing decision components.

12. The method of claim 11 wherein the decision components are chosen from the group comprising: networks, processors, signature not required, issuer, regulated, commercial cards, pre-paid; and country code.

13. The method of claim 12 wherein for networks each debit card can be processed by one or more networks, each of which may have different costs considered when guiding the purchasing process.

14. The method of claim 12 wherein for processors, requests for payments on credit or debit card are electronically communicated to a payment processor which authorizes the payment through an appropriate network and charges a fee.

15. The method of claim 12 wherein charges associated with the card issuer are determined.

16. The method of claim 12 wherein a determination is made as to whether or not the card is a commercial card or gift card.

17. The method of claim 12 wherein the country code is considered and additional fees determined based upon the country of origin of the card or card issuer.

18. A system for managing the authorization of a payment, based on a request for payment, that minimizes the fees charged and maximizes the fees received, the system comprising: a first input interface for communicating first information to a processor, the first information identifying at least a payee account; a second input interface for communicating second information to a processor; the second information chosen from the group containing amount to be paid, desired payment method, and any cash back desired; a third input interface for communicating third information to processor; the third information chosen from the group containing permitted authorization methods and payee account handling options based on the prefix of the payee account; a fourth input interface for communicating fourth information to a processor; the fourth information chosen from the group containing the configuration of desired payee account handling based on the second information and third information derived from the first information and wherein the processor provides an output, the output being a recommended way to authorize a payee account.

19. The system of claim 18 wherein the output further comprises information on additional payee information to include in the authorization.

20. The system of claim 18 wherein the First Information comprises credit or debit account information entered at a PIN Pad (Payment Terminal); the Second Information comprises payment amount and any cash back decisions entered at a Point of Sale or Payment Terminal; the Third Information comprises a BIN database of bank card prefixes; and the Fourth Information comprises system configuration parameters.
